(19) United States
(12) Patent Application Publication
(10) Pub. No.: US 2025/0387808 A1
(43) Pub. Date: Dec. 25, 2025

(54) METHODS AND SYSTEMS FOR CLEANING EQUIPMENT WITH SOLVENTS

(71) Applicant: ZymeFlow, Inc., Houston, TX (US)

(72) Inventor: Stephen D. Matza, Sugar Land, TX (US)

(73) Assignee: ZymeFlow, Inc., Houston, TX (US)

(21) Appl. No.: 18/948,091

(22) Filed: Nov. 14, 2024

Related U.S. Application Data
(60) Provisional application No. 63/663,630, filed on Jun. 24, 2024.

(51) Int. Cl. B08B 3/08; B08B 3/10; C11D 1/66

(52) U.S. Cl. CPC B08B 3/08; B08B 3/10; C11D 1/667

(57) ABSTRACT

A method for decontaminating fouled equipment including deposits includes (a) introducing a water-containing cleaning stream comprising a carrier fluid and a solvent into the equipment. In addition, the method includes (b) introducing a stream comprising nitrogen into the equipment after (a).

### CROSS-REFERENCE TO RELATED APPLICATIONS

This application claims priority to U.S. Provisional Application Ser. No. 63/663,630 filed on Jun. 24, 2024 and entitled “Method for Cleaning a Vessel with Solvent,” which is hereby incorporated herein by reference in its entirety for all purposes.

### STATEMENT REGARDING FEDERALLY SPONSORED RESEARCH OR DEVELOPMENT

Not applicable.

### FIELD

The present disclosure relates generally to the methods and systems for cleaning industrial equipment using one or more solvents. More particularly, the present disclosure relates to methods and systems for removing deposits from refinery equipment.

### BACKGROUND

Refineries may make use of equipment, for example, vessels, such as reactors having hydrogenation catalysts disposed therein to produce certain value-added products or remove contaminants to improve purity. Over time, the catalyst(s) disposed within the reactor may lose performance either due to catalyst poisoning or buildup of hydrocarbon deposits, which may block active sites on the catalyst. Proper maintenance of these reactors may require that the catalyst undergo cleaning and/or decontamination, in some cases, prior to unloading and changeout of the catalyst.

For example, during the refinement process of crude oil and natural gas, reactors may be used to produce various products from a hydrocarbon feed stream. Reactors may include a catalyst that may promote conversion from a reactant to a product. Catalysts may allow for reactions to occur at lower severity (for example, lower temperature and pressure) and with greater selectivity to desired products by providing an alternative reaction mechanism with a lower activation energy than a non-catalyzed mechanism. Catalysts are a critical component of hydrocarbon processing and catalyst performance may determine quality of the products and profitability of a hydrocarbon processing operation. As such, catalyst performance is often a closely monitored metric in the operation of a reactor. Some common hydrocarbon processing operations that use catalyst may include cracking, such as fluidized catalytic cracking and thermal cracking, hydroprocessing and/or hydrogenation such as hydrotreating and hydrocracking, isomerization, catalytic reformation, dehydrogenation, and other operations well known in the art.

Carbon deposits, often referred to as “coke,” may degrade or “foul” reactors and the catalyst disposed therein. The formation of coke is generally undesirable as the coke may collect on the surface of catalyst, thereby reducing catalytic activity. While process design and process operation may reduce the amount of coke formed, the complete elimination of coke forming reactions may not be possible in all processes. Once a catalyst has been fouled by coke deposits, for example, to an extent that the performance of the catalyst is diminished, the catalyst may require regeneration to regain catalytic activity. In addition to coke, other contaminants may be deposited on the reactor vessel and catalyst. Contaminants including coke may be referred to collectively herein as “deposits.” The additional contaminants are generally process specific and may include hydrocarbons such as saturated and unsaturated hydrocarbon, aromatic hydrocarbons such as benzene, as well as gums, resins, heavy oil deposits, oligomers, and porphyrins containing nickel and vanadium, for example. In some systems that process sour hydrocarbons, hydrogen sulfide (H₂S) may also be a contaminant.

Due to the reduction in catalytic activity induced by coke and other deposits, catalysts may be periodically regenerated to regain catalytic activity as part of the operation of the reactor. In addition to on stream regeneration, most units may be periodically shut down during a plant turnaround to remove fouling and regenerate catalyst. During routine maintenance of equipment such as during a turnaround event, removal of catalyst from equipment and/or entry into the equipment may be necessary. There may be many challenges to removing fouled catalyst such as the catalyst becoming immobile from coke deposition and agglomeration of the catalyst into larger pieces, which may impair removal efforts. Coke and other deposits described above may be agglomerated on internals of reactors, which may cause the internals to become difficult to remove.

Furthermore, residual deposits such as coke, hydrogen sulfide, and other hydrocarbons present in the equipment may pose a fire hazard when the equipment is opened to remove catalyst or for entry. The lower explosive limit (LEL) refers to the lowest concentration of a vapor in air capable of producing a fire when exposed to an ignition source. Controlling vapor concentrations within reactors to below the LEL to allow for safe removal of catalyst and vessel entry may be a concern for operators as regulations and safety requirements dictate that LEL must be controlled before a vessel can be opened. In general, a vapor that poses a fire hazard when exposed to an ignition source, and hence exhibits an LEL, may be referred to herein as an “LEL vapor.”

Various techniques have been developed to enable removal of deposits from catalyst that also reduce LEL vapor concentrations below the LEL. The particular techniques used to remove deposits and reduce LEL vapor concentrations to a level below LEL may depend upon the particular catalyst and equipment in which the catalyst is present. Furthermore, the de-coking and vapor removal treatment may inadvertently introduce catalyst poison(s) that may reduce the activity of the catalyst after treatment.

Other techniques for removal of deposits may include a hydrogen (H₂) sweep followed by a nitrogen purge. The hydrogen sweep method may remove at least a portion of hydrocarbon vapors and hydrogen sulfide but may not be effective to bring the hydrocarbon vapors and hydrogen sulfide down to acceptable levels for vessel entry, that is, less than LEL. Another method may comprise a hot hydrogen strip followed by nitrogen. The hydrogen may be introduced into the equipment at an elevated temperature, for example, 700° F. (341° C.) or greater. A nitrogen purge may then be used to push out any residual hydrogen and hydrocarbons, reduce the LEL (for example, hydrocarbon) vapors to below the LEL, and reduce the temperature to an acceptable entry level. The hydrogen sweep is a relatively slow process and may require several days to complete, thereby increasing the costs associated with the treatment.

### BRIEF SUMMARY OF THE DISCLOSURE

Embodiments of methods for decontaminating fouled equipment comprising deposits are disclosed herein. In one embodiment, a method for decontaminating fouled equipment comprising deposits comprises (a) introducing a cleaning stream into the equipment. The cleaning stream comprises a water-containing carrier fluid and a solvent. In addition, the method comprises (b) introducing a stream comprising nitrogen into the equipment after (a).

In another embodiment, a method for decontaminating fouled equipment comprising deposits comprises (a) adding water to a hydrogen stream to form a carrier fluid. In addition, the method comprises (b) heating the carrier fluid after (a) to form a heated carrier stream. Further, the method comprises (c) adding a solvent to the heated carrier stream after (b) to form a cleaning stream. Still further, the method comprises (d) flowing the cleaning stream into the fouled equipment after (c). The method also comprises (e) contacting the deposits in the fouled equipment with the cleaning stream during (d). Moreover, the method comprises (f) absorbing and/or disaggregating the deposits in the fouled equipment during (e).

Embodiments of systems for decontaminating fouled equipment comprising deposits are disclosed herein. In one embodiment, a system for decontaminating fouled equipment comprising deposits comprises a water-containing cleaning stream comprising a carrier fluid and a solvent. The water-containing cleaning stream is configured to be disposed within the fouled equipment. The water-containing cleaning stream comprises from about 50 ppm by wt. to about 10,000 ppm by wt. of water.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 illustrates a schematic view of an embodiment of a system and process flow streams for cleaning and/or decontaminating fouled equipment comprising deposits in accordance with principles disclosed herein.

### DETAILED DESCRIPTION

The following disclosure includes various exemplary embodiments. However, one skilled in the art will understand that the examples disclosed herein have broad application, and that the discussion of any embodiment is meant only to be exemplary of the disclosed subject matter and not intended to suggest that the scope of the disclosure or the claims is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function, unless so-indicated explicitly or by context. The drawing figures are not necessarily to scale. Certain features and components herein may be shown exaggerated in scale or in somewhat schematic form and some details of conventional elements may not be shown in interest of clarity and conciseness.

Unless the context dictates to the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device is coupled to a second device, that connection may be through a direct engagement between the two devices, or through an indirect connection that is established via other devices, components, nodes, and connections. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Disclosed herein are embodiments of methods and systems for cleaning fouled industrial equipment containing or comprising undesirable and contaminating deposits. Generally, the disclosed methods and systems may comprise introduction of a solvent into a carrier fluid such that the solvent is at least partially volatilized in the carrier fluid, delivery of the carrier fluid and the solvent at least partially volatilized in the carrier fluid into the industrial equipment, and interaction between the solvent at least partially volatilized in the carrier fluid and the deposits such that the deposits are at least partially removed from the industrial equipment.

In various embodiments, the disclosed methods and systems may be employed in the removal of a deposit from any fouled industrial equipment including, but not limited to, reactors, vessels, tanks, vacuum towers, heat exchangers, piping, distillation columns, and the like. In some embodiments, the methods and systems may be employed in the removal of deposits from equipment associated with applications including, but are not limited to, olefins processing, fluid catalytic cracking, hydrotreating, ammonia processing, and other processes that use a catalyst. In various embodiments, more particularly, the methods and systems may be employed in the removal of deposits from equipment that comprises a catalyst, examples of which may include cracking catalysts, such as may be suitable for fluidized catalytic cracking and thermal cracking, hydroprocessing and/or hydrogenation catalysts, such as hydrotreating catalysts, hydrocracking catalysts, isomerization catalysts, reformation catalysts, and dehydrogenation catalysts.

Specific examples of catalysts include, but are not limited to, a hydrogenation catalyst that generally includes a Group VIII metal and/or a Group VI metal, more particularly, a Group VIIIB metal and/or Group VIB metal. Examples of such a catalyst may include, but are not limited to, Cu, Re, Ni, Fe, Co, Ru, Pd, Rh, Pt, Os, Ir, alloys thereof, and combinations thereof, either alone or with promoters such as W, Mo, Au, Ag, Cr, Zn, Mn, Sn, B, P, Bi, alloys thereof, and combinations thereof. In some embodiments, the hydrogenation catalyst may also include a support, as described below, depending upon factors including the desired functionality of the catalyst. The hydrogenation catalysts may be prepared by methods known to those of ordinary skill in the art.

As an example, in some embodiments, the hydrogenation catalyst includes a supported Group VIII metal catalyst and a metal sponge material (e.g., a sponge nickel catalyst). An example of an activated sponge nickel catalyst is Raney nickel. Specific examples of catalysts include nickel-rhenium catalysts, tungsten-modified nickel catalysts, carbon-supported nickel-rhenium catalysts, cobalt-molybdenum catalysts, nickel-molybdenum catalysts, zeolite catalysts, and combinations thereof.

In some embodiments, the hydrogenation catalyst may include a catalyst support. The catalyst support stabilizes and supports the catalyst. The type of catalyst support used depends on the chosen catalyst and the reaction conditions. Suitable supports may include, but are not limited to, carbon, silica, silica-alumina, alumina, zirconia, titania, ceria, vanadia, nitride, boron nitride, heteropolyacids, hydroxyapatite, zinc oxide, chromia, zeolites, carbon nanotubes, carbon fullerenes, and combinations thereof.

Also, in various embodiments, the disclosed methods and systems may be effective for the removal of a sufficient amount one or more deposits including, but not limited to a contaminant material produced, stored, transported, or the like during the process of crude oil refinement, natural gas processing, hydrocarbon transport, hydrocarbon processing, hydrocarbon cleanup, and the like. In various embodiments, examples of deposits may include residual oil, hydrogen sulfide, combustible gas, coke, oligomers, other contaminant materials, and combinations thereof.

In some embodiments, the deposit(s) are contacted with the carrier fluid and solvent such that the deposits are disaggregated and/or dissolved, and may then be subsequently removed from the industrial equipment by flowing the deposits out of the equipment via the carrier fluid, hydrogen, nitrogen gas, such as a nitrogen purge, or combinations thereof.

In various embodiments, the carrier fluid may comprise a gas. In some embodiments, the carrier fluid comprises nitrogen gas, hydrogen gas, or another inert gas. Additionally or alternatively, the carrier fluid may comprise a hydrocarbon gas comprising predominantly C1, C2, C3, C4, and C5 alkanes defined by the formula CₙH₂ₙ₊₂, where n is an integer of at least 1 and not more than 5. Examples of such dry gas include ethane, methane, propane, butane, pentane, and combinations thereof. In various embodiments, the carrier fluid may comprise at least 95 wt. %. of the nitrogen gas, hydrogen gas, another inert gas, or hydrocarbon gas; additionally or alternatively, at least 96 wt. %; additionally or alternatively, at least 97 wt. %; additionally or alternatively, at least 98 wt. %; additionally or alternatively, at least 99 wt. %; additionally or alternatively, at least 99.5 wt. %; additionally or alternatively, at least 99.9 wt. %; additionally or alternatively, at least 99.95 wt. %; additionally or alternatively, at least 99.99 wt. %; additionally or alternatively, at least 99.995 wt. %; additionally or alternatively, at least 99.999 wt. %, of the nitrogen gas, hydrogen gas, another inert gas, or hydrocarbon gas.

In some embodiments, the carrier fluid may further comprise water. As will be appreciated by those of skill in the art with the aid of this disclosure, the phase of water (for example, liquid water or steam) present within the carrier fluid may be dependent upon various characteristics of the carrier fluid, for example, temperature and pressure. For example, the water may be substantially present as steam. In various embodiments, water may be present in the carrier fluid in an amount such that, when the solvent is combined with the carrier fluid, as will be disclosed herein, the water is present in the combined carrier fluid and solvent in an amount of at least a lower threshold and/or at most an upper threshold, as disclosed herein below. For example, the lower threshold may be at least 50 ppm by wt., at least 100 ppm by wt., at least 200 ppm by wt., at least 300 ppm by wt., at least 500 ppm by wt., at least 600 ppm by wt., at least 700 ppm by wt., at least 800 ppm by wt., at least 900 ppm by wt., or at least 1,000 ppm by wt. Additionally or alternatively, the upper threshold may be at most 20,000 ppm by wt., at most 10,000 ppm by wt., at most 5,000 ppm by wt., at most 4,000 ppm by wt., at most 4,000 ppm by wt., at most 3,500 ppm by wt., at most 3,000 ppm by wt., at most 2,500 ppm by wt., at most 2,000 ppm by wt., at most 1,500 ppm by wt., at most 1,250 ppm by wt., at most 1,100 ppm by wt., or at most 750 ppm by wt.

Generally, the solvent may be any compound or combination of compounds suitably employed for refinery equipment cleaning and/or removal of hydrocarbon LEL vapors above the LEL. For example, the solvent may be effective to improve or enhance the removal deposits such as hydrocarbons and hydrogen sulfide, to lower the concentration of hydrocarbon vapors in the refinery equipment, for example, within a head space of the equipment, or combinations thereof.

In some embodiments, the solvent may include an organic compound, for example, an aliphatic compound, a paraffinic compound, an isoparaffinic compound, an aromatic compound, a naphthenic compound, an olefinic compound, a diene compound, a terpene compound, a polymeric compound, a halogenated compound, or combinations thereof. Examples of such solvents include, but are not limited to, naturally-occurring terpenes, hydrogenated derivatives of such naturally-occurring terpenes, and hydrocarbons. Other examples of the solvent may include aromatic compounds such as toluene and/or xylene.

Also for example, in some embodiments, the solvent may comprise a refinery cutting fluid and a hydrocarbon solvent. The refinery cutting fluid may be any material capable of being naturally distilled from crude oil. At many refineries, crude oil comprising a mixture of various hydrocarbons may undergo a distillation process. The distillation process aims to separate the crude oil into its various components including, without limitation, residual fuel oil, heavy gas oil, distillate (diesel), kerosene, naphtha, gasoline blending components, butane, and lighter products. In utilizing a naturally occurring refinery cutting fluid, utility costs for producing the solvent may be lowered and the flash point for shipping the solvent composition may be increased. In some embodiments, the refinery cutting fluid may comprise diesel, kerosene, naphtha, or a combination thereof.

In embodiments, the hydrocarbon solvent may be any hydrocarbon compound. In some embodiments, the hydrocarbon compound may be bicyclic including two fused benzene rings. The two fused benzene rings may be aromatic, saturated, or a combination thereof. In some embodiments and not intending to be bound by theory, the two fused benzene rings may include one aromatic ring and one saturated ring, which may result in a hydrocarbon compound with a high Kauri Butanol (Kb) value. The Kb value is a standardized measure of solvent power for a hydrocarbon solvent. In some embodiments, the hydrocarbon solvent may have a Kb value ranging from about 120 Kb to about 150 Kb, or alternatively ranging from about 130 Kb to about 140 Kb. In some embodiments, the hydrocarbon solvent may have a Kb value of 132 Kb. A suitable hydrocarbon solvent may comprise, without limitation, naphthalene, tetralin, decalin, or a combination thereof. In embodiments, the hydrocarbon solvent may be tetralin.

In some embodiments, the solvent comprises a fatty acid methyl ester and/or an oxygenated solvent. In some embodiments, the fatty acid methyl ester may comprise structure (1) below, where R is a C14-C18 alkyl group.

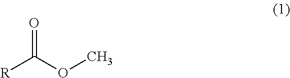

In some aspects, the fatty acid methyl ester may be the product of transesterification of soybean oil with methanol, for example, methyl soyate. The fatty acid methyl ester may also be a biodiesel or a biodiesel equivalent blend.

In embodiments, the oxygenated solvent may comprise glycol ethers such as di-propylene glycol, alcohols such as benzyl alcohol, esters such as ethyl lactate, ethoxylated alcohols, glycol ether acetates, or a combination thereof. In some embodiments, the oxygenated solvent may be effective to remove or lower the concentration of hydrocarbons LEL vapors, for example, aromatic dispersed combustible materials, thereby lowering the levels of LEL vapors. Lowering the levels of LEL vapors may promote safe and effective vessel entry.

In some embodiments with the fatty acid methyl ester and oxygenated solvent both present, the fatty acid methyl ester and oxygenated solvent may be present in any ratio in the solvent composition. Without limitation, the amount of fatty acid methyl ester and oxygenated solvent may depend on a variety of factors including the identity of the fatty acid methyl ester and oxygenated solvent. For example, in some embodiments, the fatty acid methyl ester may be present in an amount ranging from about 70% to about 100% by volume of the solvent composition with the balance volume being the oxygenated solvent or combination of aforementioned oxygenated solvents. Additionally or alternatively, the fatty acid methyl ester may be present at a point in a range of about 70% to about 75% by volume, about 75% to about 80% by volume, about 85% to about 90% by volume, about 90% to about 95% by volume, about 95% to about 99.5%, or about 99.5% to about 100% by volume of the solvent composition, or any value in between the explicitly stated ranges. One of ordinary skill in the art with the aid of this disclosure should be able to select an appropriate identity and amount of fatty acid methyl ester and oxygenated solvent for a particular application.

In some embodiments, the boiling point of the solvent used is less than about 840° F. (about 450° C.). More particularly, in some embodiments, the solvent may be characterized as exhibiting a boiling point ranging from about 260° F. (about 125° C.) to about 570° F. (about 300° C.) depending on the identity and volumetric ratio of the chemical species in the solvent composition. In some embodiments, a relatively higher boiling point solvent may be advantageous, for example, in that vapor phase solvents may exhibit higher performance at relatively higher temperatures. In some embodiments, for example, the methods and systems disclosed herein may be carried out at relatively high temperatures ranging from about 500° F. (about 260° C.) to about 750° F. (about 400° C.). In some embodiments, a relatively lower boiling point solvent may be advantageous, for example, in that the vapor phase solvents may allow for the solvent composition to be introduced into industrial equipment operating at lower temperatures. In some embodiments, for example, the methods and systems disclosed herein may be carried out, such as when using a solvent composition having a relatively lower boiling point, at relatively low temperatures ranging from about 300° F. (about 150° C.) to about 570° F. (about 300° C.).

In some embodiments, the solvent may further comprise water, for example, as a dispersed phase within the solvent and/or a dissolved phase (e.g., when an oxygenated solvent is used). In various embodiments, water may be present in the solvent in an amount such that, when the solvent is combined with the carrier fluid, as will be disclosed herein, the water is present in the combined carrier fluid and solvent in an amount of at least a lower threshold and/or at most an upper threshold, as disclosed herein below. Additionally or alternatively, the water may be present in the solvent in an amount of at least a lower threshold and/or at most an upper threshold. For example, the lower threshold may be at least 50 ppm by wt., at least 100 ppm by wt., at least 200 ppm by wt., at least 300 ppm by wt., at least 500 ppm by wt., at least 600 ppm by wt., at least 700 ppm by wt., at least 800 ppm by wt., at least 900 ppm by wt., or at least 1,000 ppm by wt. Additionally or alternatively, the upper threshold may be at most 20,000 ppm by wt., at most 10,000 ppm by wt., at most 5,000 ppm by wt., at most 4,000 ppm by wt., at most 4,000 ppm by wt., at most 3,500 ppm by wt., at most 3,000 ppm by wt., at most 2,500 ppm by wt., at most 2,000 ppm by wt., at most 1,500 ppm by wt., at most 1,250 ppm by wt., at most 1,100 ppm by wt., or at most 750 ppm by wt.

In various embodiments, the solvent and the carrier fluid may be present in any suitable ratio in the combined carrier fluid and solvent. One of ordinary skill in the art with the benefit of this disclosure should be able to select an appropriate identity and amount of the hydrocarbon solvent and cutting fluid for a particular application.

Generally, in some embodiments, the disclosed methods and systems may be effective to remove deposits from equipment, more particularly, by introducing the carrier fluid comprising the solvent into the equipment. The solvent may be present in any suitable amount in the carrier fluid, depending on various factors including, but not limited to, vessel size; the presence, absence, or volume of catalyst in the vessel; and the type and amount of deposits or fouling.

The deposit removal method may include injecting the combined carrier fluid and solvent into the equipment at an elevated temperate, for example, to heat to and/or maintain the equipment at the elevated temperature. For example, the carrier fluid may be introduced into the equipment at a temperature ranging from about 390° F. (about 200° C.) to about 810° F. (430° C.), or any temperature in-between, depending on the particular application. The carrier fluid and solvent may be heated by any suitable method and/or apparatus including, for example, an electric or a fired heater. One of ordinary skill in the art, with the benefit of this disclosure, should be able to select an appropriate temperature for a particular application.

Not intending to be bound by theory, the elevated temperature may be effective to yield improved removal of deposits, for example, by improving disaggregation and dissolution of the deposits present in the equipment. In some embodiments, the solvent may be introduced into a heated stream of the carrier fluid, which may cause the solvent to at least partially vaporize, volatilize, and/or be dispersed in the carrier fluid, and be subsequently carried into the equipment in a gaseous of substantially gaseous phase. For example, in various embodiments, at least about 75 wt. % of the solvent may be gaseous; additionally or alternatively, at least about 80 wt. % of the solvent; additionally or alternatively, at least about 85 wt. % of the solvent; additionally or alternatively, at least about 90 wt. % of the solvent; additionally or alternatively, at least about 95 wt. % of the solvent; additionally or alternatively, at least about 97.5 wt. % of the solvent; additionally or alternatively, at least about 98 wt. % of the solvent; additionally or alternatively, at least about 99 wt. % of the solvent; additionally or alternatively, at least about 99.5 wt. % of the solvent; additionally or alternatively, at least about 99.75 wt. % of the solvent; additionally or alternatively, at least about 99.9 wt. % of the solvent; additionally or alternatively, at least about 99.95 wt. % of the solvent may be gaseous. In some aspects, the solvent may be entirely vaporized during use.

Generally, the gaseous or substantially gaseous solvent may contact deposits in the equipment and cause the deposits to be loosened or disaggregated, or to become solvated by the solvent. For example, the loosening, disaggregation, and/or solvation of the deposits may render the deposits transportable such that the deposits (or portions of the deposits) may flow out from the equipment.

The stream exiting the equipment may be passed to a collection vessel such that the deposits (or portions of the deposits) may be collected for disposal. At least a portion of the carrier fluid may be collected, recycled, and heated again so that additional solvent composition may be added. The recycled carrier fluid may be passed to the equipment to further remove more deposits.

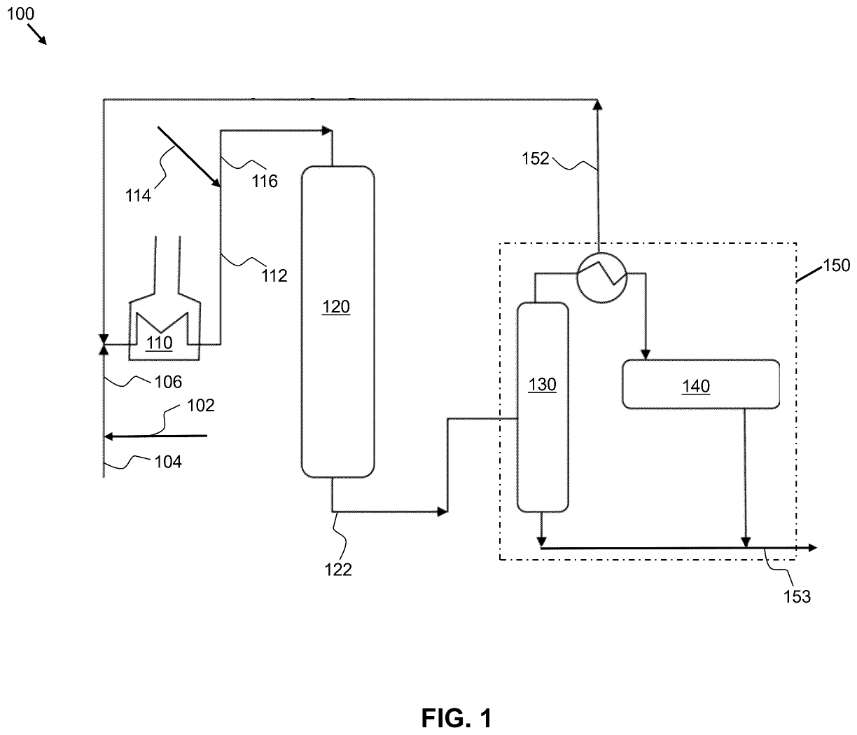

Referring now to FIG. 1, a schematic process flow diagram is shown, illustrating a system 100 in according to one or more of the disclosed embodiments. The system 100 includes fouled equipment 120, a heater 110, and separation equipment 150. In this embodiment, separation equipment 150 includes, for example, a hot separator 130 and a cold separator 140. In general, the fouled equipment 120 may comprise industrial equipment or vessels including, but not limited to, reactors, vessels, tanks, vacuum towers, heat exchangers, piping, distillation columns, and the like. Fouled equipment 120 comprises deposits of any of the fouling compounds previously discussed including, without limitation, coke, hydrogen sulfide, unsaturated hydrocarbons, aromatic hydrocarbons such as benzene, as well as gums, resins, heavy oil deposits, and oligomers, for example.

As shown in FIG. 1, water 102 (for example, which may be introduced as liquid water and/or steam) is introduced into a gas stream 104 to form a carrier fluid 106. In this embodiment, the gas stream 104 is a hydrogen gas stream, and thus, may also be referred to as hydrogen 104 or hydrogen stream 104. In other embodiments, the gas stream (e.g., gas stream 104) comprise nitrogen gas, another inert gas, or a hydrocarbon gas comprising predominantly C1, C2, C3, C4, and C5 alkanes defined by the formula CₙH₂ₙ₊₂, where n is an integer of at least 1 and not more than 5 (e.g., methane, ethane, propane, butane, pentane, or combination thereof). In various embodiments, the carrier fluid 106 comprises at least 95 wt. %. of the gas stream 104; additionally or alternatively, at least 96 wt. % of the gas stream 104; additionally or alternatively, at least 97 wt. % of the gas stream 104; additionally or alternatively, at least 98 wt. % of the gas stream 104; additionally or alternatively, at least 99 wt. % of the gas stream 104; additionally or alternatively, at least 99.5 wt. % of the gas stream 104; additionally or alternatively, at least 99.9 wt. % of the gas stream 104; additionally or alternatively, at least 99.95 wt. % of the gas stream 104; additionally or alternatively, at least 99.99 wt. % of the gas stream 104; additionally or alternatively, at least 99.995 wt. % of the gas stream 104; additionally or alternatively, at least 99.999 wt. of the gas stream 104. Although FIG. 1 illustrates the introduction of the water 102 upstream of the heater 110, in other embodiments the water 102 may be introduced at various additional or alternative points upstream of the fouled equipment 120.

The carrier fluid 106 is introduced to the heater 110, for example, a furnace or heat exchanger. The heater 110 heats the carrier fluid 106 to a desired temperature to form a heated carrier stream 112. The heated carrier stream 112 may be heated to, for example, a temperature ranging from about 390° F. (about 200° C.) to about 810° F. (about 430° C.) and, additionally or alternatively, ranging from about 390° F. (about 200° C.) to about 500° F. (about 260° C.).

A solvent 114 is injected into the heated carrier stream 112 to form a combined stream 116 upstream of the fouled equipment 120. Thus, the combined stream 116 is a mixture of the heated carrier fluid 112, which includes the hydrogen stream 104 and the water 102, and the solvent 114. Generally, the solvent 114 may be injected into the heated carrier stream 112 such that the solvent is at least partially vaporized, volatilized, dispersed, or combinations thereof in the heated carrier stream 112, and then carried into the fouled equipment 120 as a part of the combined stream 116. Although the solvent 114 is shown in FIG. 1 as being injected into the heated carrier stream 112 at a single point downstream of the heater 110 and upstream of the fouled equipment 120, in other embodiments, the solvent 114 can be injected at one or more additional or alternative locations. In various embodiments, the solvent may be injected via suitable equipment, such as one or more additive pumps.

The combined stream 116 is introduced into fouled equipment 120 whereby the heated carrier stream 112 and the solvent 114 of the combined stream 116 may act to loosen and/or dissolve deposits within fouled equipment 120. Accordingly, the combined stream 116 may also be referred to herein as a “cleaning” stream. Equipment output stream 122 exiting the fouled equipment 120 may comprise, for example, hydrogen (e.g., any hydrogen remaining from the combined stream 116), solvent (e.g., any remaining portion of the solvent 114 from the combined stream 116), dissolved deposits, disaggregated deposits, LEL vapors, benzene, hydrogen sulfide, and some amount of water (e.g., any remaining water 102 from the combined stream 116, water formed in the equipment 120, or combinations thereof).

The equipment output stream 122 exits the fouled equipment 120 and is introduced to separation equipment 150, for example, the hot separator 130 and cold separator 140. In general, the separation equipment 150 includes equipment configured to separate the components of equipment output stream 122. For example, the separation equipment 150 may separate the components of the carrier fluid 106 (e.g., hydrogen and, in some embodiments water) from the solvent 114 and deposits present in the equipment output stream 122. The separation equipment 150 may comprise any equipment such as, without limitation, a suitable configuration/combination of refrigerated heat exchangers, air cooled heat exchangers, integrated heat exchangers tanks, vessels, coalescers, knock out drums, demister systems, hot separators, cold separators, de-oilers, and processes such as amine columns and caustic towers, which may treat sour components or hydrogen sulfide present in the equipment output stream 122. In the embodiment of FIG. 1, the separation equipment 150 separates at least a portion of the gas from the gas stream 104 (e.g., hydrogen) from undesirable components 153 such as hydrogen sulfide, LEL vapors, a portion of the solvent 114, and contamination deposits removed from the equipment 120. Additionally, in some embodiments, the separation equipment may be operated under conditions (e.g., at a temperature and pressure) sufficient to separate water from the undesirable components. In some embodiments, some of the undesirable components 153 may be directed to a flare. The separated gas (e.g., hydrogen and, in some embodiments water) form a vaporous recycle stream 152, which has a composition that is the same or substantially the same as the carrier fluid 106 and may be returned to the heater 110 to be recycled.

In some embodiments, such as shown in FIG. 1, once the concentration of deposits in the equipment output stream 122 has reached the desired level, a nitrogen stream may be introduced into system 100 and flowed therethrough by any suitable means. In an embodiment, the nitrogen stream is not introduced by a pump. Without limitation, the nitrogen stream may be effective to push or “sweep” hydrogen, hydrogen sulfide, solvent, LEL vapors, benzene, and the like out of the equipment 120. In some embodiments, the nitrogen stream is not heated. For instance, without limitation, the nitrogen stream is not heated in some embodiments because ammonia may be produced at a temperature above 500° F. (260° C.). The nitrogen stream flows into and through the equipment 120, thereby displacing the hydrogen and solvent, and may further reduce the hydrocarbon concentration in the vapor space in equipment 120 through displacement. The nitrogen stream may be introduced and flowed through the system 100 until the concentration of LEL vapors leaving the fouled equipment 120 are at a desired level, generally below the LEL of the LEL vapors or at a particular ppm measurement for the LEL vapors. In embodiments, a desired target for hydrogen sulfide is below about 10 ppm. In an embodiment, a desired target is to reduce LEL vapors to about 10% or less of the LEL.

In some embodiments, prior to performing the cleaning operation shown in FIG. 1, the system 100 may be purged with a solvent-free hydrogen stream. In such embodiments, the solvent-free hydrogen stream may be flowed through system 100 at a temperature ranging from about 500° F. (about 260° C.) to about 810° F. (about 430° C.). In some embodiments, the solvent-free hydrogen stream may be effective to reduce the presence of and/or purge a portion of various contaminants such as LEL vapors and hydrogen sulfide present within a vessel, for example, the equipment 120.

In some embodiments, the presence of water in the combined stream 116 may be advantageous in the operations disclosed herein. Such water in the combined stream 116 may arise from various sources including the water 102 injected into the gas stream 104 to form the carrier fluid 106, water present in the solvent 114 injected into the heated carrier stream 112, water introduced into the combined stream 116, or a combination thereof. Additionally or alternatively, in some embodiments the water may be present in the vaporous recycle stream 152 as a result of the formation (e.g., catalytically) of water in the equipment 120 during the cleaning and/or decontamination operations as disclosed herein. As previously disclosed herein, in some embodiments the equipment (e.g., the fouled equipment 120) may be a reactor or other vessel comprising a catalyst. Not intending to be bound by theory, the catalyst in the equipment may be effective to catalytically produce water from one or more components in contact with the catalyst during the cleaning and/or decontamination operation. For example, in some embodiments, the catalyst may be effective to catalytically generate water where one or more oxygen-containing species, such as an oxygenated solvent and/or a fatty acid methyl ester as disclosed herein, is in contact with hydrogen in the presence of the catalyst. As previously described, the vaporous recycle stream 152 may form at least a portion of the carrier fluid 106, and thus, any water in the vaporous recycle stream 152 may also be present in the carrier fluid 106, and thus, remains present in the heated carrier fluid 112 and the combined stream 116.

In various embodiments, the concentration of water present in the combined stream 116 (from all sources), which is fed into the equipment 120, is greater than or equal to a lower threshold value and/or is less than or equal to an upper threshold value. For example, the lower threshold value may be at least 50 ppm by wt., at least 100 ppm by wt., at least 200 ppm by wt., at least 300 ppm by wt., at least 500 ppm by wt., at least 600 ppm by wt., at least 700 ppm by wt., at least 800 ppm by wt., at least 900 ppm by wt., at least 1,000 ppm by wt., at least 1,500 ppm by wt., at least 2,000 ppm by wt., at least 2,500 by wt., at least 3,500 ppm by wt., at least 4,000 ppm by wt., at least 4,500 ppm by wt., or at least 5,000 ppm by wt. Additionally or alternatively, the upper threshold value may be at most 20,000 ppm by wt., at most 10,000 ppm by wt., at most 5,000 ppm by wt., at most 4,000 ppm by wt., at most 4,000 ppm by wt., at most 3,500 ppm by wt., at most 3,000 ppm by wt., at most 2,500 ppm by wt., at most 2,000 ppm by wt., at most 1,500 ppm by wt., at most 1,250 ppm by wt., at most 1,100 ppm by wt., or at most 750 ppm by wt.

In various embodiments, for example, the presence of water in the combined stream 116 fed into the equipment 120 may be effective to improve and/or enhance the removal of deposits. This is particularly useful in industrial processes where the thorough cleaning of residual hydrocarbons is essential. For example, and not intending to be bound by theory, the presence of water in the combined stream 116 may be effective to enhance the removal of deposits by facilitating the hydrolysis of hydrocarbons present in the deposits, thereby causing the deposits to be broken them down into simpler, more volatile compounds that are more easily removed. Additionally or alternatively, the presence of water in the combined stream 116 fed into the equipment 120 may contribute to the presence of conditions under which hydrocarbons present in the deposits may undergo steam reforming reactions, thereby causing hydrocarbons to be converted into hydrogen and carbon oxides. Additionally or alternatively, the presence of water in the combined stream 116 fed into the equipment 120 may improve the efficiency of hydrogenation reactions in which unsaturated hydrocarbons become hydrogenated thereby converting the unsaturated hydrocarbons into saturated hydrocarbons, which may be more easily removed. Additionally, the presence of water in the combined stream 116 fed into the equipment 120 may also contribute to the partial oxidation of hydrocarbons present in the deposits, thereby rendering the hydrocarbons more reactive and thereby more easily removed.

The following additional embodiments demonstrated various aspects of the subject matter disclosed and claimed herein.

A 1^{st} embodiments is a method for decontaminating fouled equipment comprising deposits, the method comprising (a) introducing a water-containing cleaning stream comprising a carrier fluid and a solvent into the equipment; and (b) introducing a stream comprising nitrogen into the equipment after (a).

A 2^{nd} embodiment is the method of the 1^{st} embodiment, further comprising (c) purging the equipment with a solvent-free hydrogen stream before (a) wherein the solvent-free hydrogen stream is at a temperature ranging from about 500° F. (about 260° C.) to about 800° F. (about 430° C.).

A 3^{rd} embodiment is the method of one of the 1^{st}-2^{nd} embodiments, wherein (a) comprises (a1) injecting the solvent into the carrier fluid; and (a2) vaporizing and/or dispersing the solvent within the carrier fluid.

A 4^{th} embodiment is the method of one of the 1^{st}-3^{rd} embodiments, wherein the solvent comprises a fatty acid methyl ester and an oxygenated solvent.

A 5^{th} embodiment is the method of the 4^{th} embodiment, wherein the fatty acid methyl ester is a product of transesterification of soy oil with methanol.

A 6^{th} embodiment is the method of the 4^{th} embodiment, wherein the fatty acid methyl ester comprises a fatty acid methyl ester with the following structure:

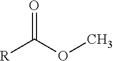

wherein R is a C₁₄-C₁₈ alkyl group.

A 7^{th} embodiment is the method of the 4^{th} embodiment, wherein the oxygenated solvent comprises a solvent selected from the group consisting of di-propylene glycol, benzyl alcohol, ethyl lactate, an ethoxylated alcohol, glycol ether acetate, and combinations thereof.

An 8^{th} embodiment is the method of one of the 1^{st}-7^{th} embodiments, wherein the solvent comprises an aliphatic compound, a paraffinic compound, an isoparaffinic compound, an aromatic compound, a naphthenic compound, an olefinic compound, a diene compound, a terpene compound, a polymeric compound, a halogenated compound, or a combination thereof.

A 9^{th} embodiment is the method of one of the 1^{st}-8^{th} embodiments, wherein the solvent has a boiling point less than about 840° F. (about 450° C.).

A 10^{th} embodiment is the method of one of the 1^{st}-9^{th} embodiments, wherein the solvent has a boiling point in a range of about 260° F. (about 125° C.) to about 570° F. (about 300° C.).

An 11^{th} embodiment is the method of one of the 1^{st}-10^{th} embodiments, further comprising absorbing the deposits and/or disaggregating the deposits within the equipment during (a); generating an output stream exiting the equipment during (a), wherein the output stream comprises hydrogen, water, the solvent, and the absorbed and/or disaggregated deposits; and removing at least a portion of the solvent and the absorbed and/or disaggregated deposits from the output stream.

A 12^{th} embodiment is the method of one of the 1^{st}-11^{th} embodiments, wherein the water-containing cleaning stream comprises from about 50 ppm by wt. to about 10,000 ppm by wt. of water.

A 13^{th} embodiment is the method of one of the 1^{st}-12^{th} embodiments, wherein the water-containing cleaning stream comprises from about 100 ppm by wt. to about 1,000 ppm by wt. of water.

A 14^{th} embodiment is the method of one of the 1^{st}-13^{th} embodiments, wherein the carrier fluid comprises at least 1,000 ppm water.

A 15^{th} embodiment is the method of the 14^{th} embodiment, further comprising injecting water into the carrier fluid upstream of the equipment before (a).

A 16^{th} embodiment is the method of the 14^{th} embodiment, further comprising absorbing the deposits and/or disaggregating the deposits within the equipment during (a); generating an output stream exiting the equipment during (a), wherein the output stream comprises hydrogen, water, the solvent, and the absorbed and/or disaggregated deposits; generating a water-containing recycle stream from the output stream; and introducing the water-containing recycle stream into the carrier fluid upstream of the equipment.

A 17^{th} embodiment is the method of the 16^{th} embodiment, wherein at least a portion of the water in the output stream is generated catalytically within the equipment.

An 18^{th} embodiment is the method of one of the 1^{st}-17^{th} embodiments, wherein the solvent comprises at least 1,000 ppm water.

A 19^{th} embodiment is the method of one of the 1^{st}-18^{th} embodiments, wherein the carrier fluid comprises water; and a gas selected from the group consisting of nitrogen gas, hydrogen gas, an inert gas, a hydrocarbon gas including predominantly C1, C2, C3, C4, and C5 alkanes defined by the formula CₙH₂ₙ₊₂, where n is an integer of at least 1 and not more than 5.

A 20^{th} embodiment is a method for decontaminating fouled equipment comprising deposits, the method comprising (a) adding water to a hydrogen stream to form a carrier fluid; (b) heating the carrier fluid after (a) to form a heated carrier stream; (c) adding a solvent to the heated carrier stream after (b) to form a cleaning stream; (d) flowing the cleaning stream into the fouled equipment after (c); (e) contacting the deposits in the fouled equipment with the cleaning stream during (d); and (f) absorbing and/or disaggregating the deposits in the fouled equipment during (e).

A 21^{st} embodiment is the method of the 20^{th} embodiment, further comprising: generating an output stream exiting the equipment during (d), (e), and (f), wherein the output stream comprises hydrogen, water, the solvent, and the absorbed and/or disaggregated deposits; separating at least a portion of the water and at least a portion of the hydrogen from the output stream to produce a recycle stream; and combining the recycle stream with the carrier fluid.

A 22^{nd} embodiment is the method of one of the 20^{th}-21^{st} embodiments, further comprising heating the carrier fluid to a temperature ranging from about 390° F. (about 200° C.) to about 810° F. (about 430° C.) before (c).

A 23^{rd} embodiment is the method of one of the 20^{th}-22^{nd} embodiments, wherein the solvent comprises a fatty acid methyl ester and an oxygenated solvent.

A 24^{th} embodiment is the method of the 23^{rd} embodiment, wherein the oxygenated solvent comprises a solvent selected from the group consisting of di-propylene glycol, benzyl alcohol, ethyl lactate, ethoxylated alcohol, glycol ether acetate, and combinations thereof; wherein the solvent comprises an aliphatic compound, a paraffinic compound, an isoparaffinic compound, an aromatic compound, a naphthenic compound, an olefinic compound, a diene compound, a terpene compound, a polymeric compound, a halogenated compound, or a combination thereof; and wherein the fatty acid methyl ester comprises a fatty acid methyl ester with the following structure:

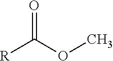

wherein R is a C₁₄-C₁₈ alkyl group.

A 25^{th} embodiment is of one of the 20^{th}-24^{th} embodiments, wherein the carrier fluid comprises at least 1,000 ppm water.

A 26^{th} embodiment is a system for decontaminating fouled equipment comprising deposits, the system comprising fouled equipment comprising deposits; and a water-containing cleaning stream comprising a carrier fluid and a solvent, wherein the water-containing cleaning fluid is configured to be disposed within the fouled equipment in contact with the deposits, and wherein the water-containing cleaning stream comprises from about 50 ppm by wt. to about 10,000 ppm by wt. of water.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A method for decontaminating fouled equipment comprising deposits, the method comprising:
(a) introducing a water-containing cleaning stream comprising a carrier fluid and a solvent into the equipment, wherein the carrier fluid wherein the carrier fluid comprises (i) at least about 50 ppm and at most about 20,000 ppm of water and (ii) a gas selected from the group consisting of nitrogen gas, hydrogen gas, an inert gas, a hydrocarbon gas including predominantly C1, C2, C3, C4, and C5 alkanes defined by the formula CnH2n+2, where n is an integer of at least 1 and not more than 5; and
(b) introducing a stream comprising nitrogen into the equipment after (a).

2. The method of claim 1, further comprising:
(c) purging the equipment with a solvent-free hydrogen stream before (a), wherein the solvent-free hydrogen stream is at a temperature ranging from about 500° F. (about 260° C.) to about 800° F. (about 430° C.).

3. The method of claim 1, wherein (a) comprises:
(a1) injecting the solvent into the carrier fluid; and
(a2) vaporizing and/or dispersing the solvent within the carrier fluid.

4. The method of claim 1, wherein the solvent comprises a fatty acid methyl ester and an oxygenated solvent.

5. The method of claim 4, wherein the fatty acid methyl ester is a product of transesterification of soy oil with methanol.

6. The method of claim 4, wherein the fatty acid methyl ester comprises a fatty acid methyl ester with the following structure: 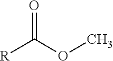
wherein R is a C14-C18 alkyl group.

7. The method of claim 4, wherein the oxygenated solvent comprises a solvent selected from the group consisting of di-propylene glycol, benzyl alcohol, ethyl lactate, an ethoxylated alcohol, glycol ether acetate, and combinations thereof.

8. The method of claim 1, wherein the solvent comprises an aliphatic compound, a paraffinic compound, an isoparaffinic compound, an aromatic compound, a naphthenic compound, an olefinic compound, a diene compound, a terpene compound, a polymeric compound, a halogenated compound, or a combination thereof.

9. The method of claim 1, wherein the solvent has a boiling point less than about 840° F. (about 450° C.).

10. The method of claim 1, wherein the solvent has a boiling point in a range of about 260° F. (about 125° C.) to about 570° F. (about 300° C.).

11. The method of claim 1, further comprising:
absorbing the deposits and/or disaggregating the deposits within the equipment during (a);
generating an output stream exiting the equipment during (a), wherein the output stream comprises hydrogen, water, the solvent, and the absorbed and/or disaggregated deposits; and
removing at least a portion of the solvent and the absorbed and/or disaggregated deposits from the output stream.

12. The method of claim 1, wherein the water-containing cleaning stream comprises from about 50 ppm by wt. to about 10,000 ppm by wt. of water.

13. The method of claim 1, wherein the water-containing cleaning stream comprises from about 100 ppm by wt. to about 1,000 ppm by wt. of water.

14. The method of claim 1, wherein the carrier fluid comprises at least 1,000 ppm water.

15. The method of claim 14, further comprising injecting water into the carrier fluid upstream of the equipment before (a).

16. The method of claim 14, further comprising:
absorbing the deposits and/or disaggregating the deposits within the equipment during (a);
generating an output stream exiting the equipment during (a), wherein the output stream comprises hydrogen, water, the solvent, and the absorbed and/or disaggregated deposits;
generating a water-containing recycle stream from the output stream; and
introducing the water-containing recycle stream into the carrier fluid upstream of the equipment.

17. The method of claim 16, wherein at least a portion of the water in the output stream is generated catalytically within the equipment.

18. The method of claim 1, wherein the solvent comprises at least 1,000 ppm water.

19. (canceled)

20. A method for decontaminating fouled equipment comprising deposits, the method comprising:
(a) adding water to a hydrogen stream to form a carrier fluid, wherein the carrier stream comprises at least about 50 ppm and at most about 20,000 ppm of water;
(b) heating the carrier fluid after (a) to form a heated carrier stream;
(c) adding a solvent to the heated carrier stream after (b) to form a cleaning stream;
(d) flowing the cleaning stream into the fouled equipment after (c);
(e) contacting the deposits in the fouled equipment with the cleaning stream during (d); and
(f) absorbing and/or disaggregating the deposits in the fouled equipment during (e).

21. The method of claim 20, further comprising:
generating an output stream exiting the equipment during (d), (e), and (f), wherein the output stream comprises hydrogen, water, the solvent, and the absorbed and/or disaggregated deposits;
separating at least a portion of the water and at least a portion of the hydrogen from the output stream to produce a recycle stream; and
combining the recycle stream with the carrier fluid.

22. The method of claim 20, further comprising heating the carrier fluid to a temperature ranging from about 390° F. (about 200° C.) to about 810° F. (about 430° C.) before (c).

23. The method of claim 22, wherein the solvent comprises a fatty acid methyl ester and an oxygenated solvent.

24. The method of claim 23,
wherein the oxygenated solvent is selected from the group consisting of di-propylene glycol, benzyl alcohol, ethyl lactate, ethoxylated alcohol, glycol ether acetate, and combinations thereof, and
wherein the fatty acid methyl ester comprises a fatty acid methyl ester with the following structure: 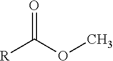
wherein R is a C14-C18 alkyl group.

25. The method of claim 20, wherein the carrier fluid comprises at least 1,000 ppm water.

26. (canceled)

27. The method of claim 20, wherein the solvent comprises an aliphatic compound, a paraffinic compound, an isoparaffinic compound, an aromatic compound, a naphthenic compound, an olefinic compound, a diene compound, a terpene compound, a polymeric compound, a halogenated compound, or a combination thereof.
